(19) United States
(12) Patent Application Publication
(10) Pub. No.: US 2025/0103539 A1
(43) Pub. Date: Mar. 27, 2025

(54) METHODS AND APPARATUS TO IMPLEMENT CXL OVER USB-C

(71) Applicant: Intel Corporation, Santa Clara, CA (US)

(72) Inventors: Kannappan Rajaraman, Bangalore (IN); Udaya Natarajan, El Dorado Hills, CA (US)

(21) Appl. No.: 18/474,001

(22) Filed: Sep. 25, 2023

(51) Int. Cl. G06F 13/42

(52) U.S. Cl. CPC G06F 13/4282; G06F 2213/0016; G06F 2213/0026; G06F 2213/0042

(57) ABSTRACT

Systems, apparatus, articles of manufacture, and methods are disclosed. An example apparatus includes a USB-C port; power delivery circuitry to determine, based on a mode-support message accessed via the USB-C port, that an external device supports Compute Express Link (CXL) as a standalone protocol over USB-C; and multiplexer management circuitry to cause the power delivery circuitry to transmit a CXL status message to the external device via the USB-C port.

### FIELD OF THE DISCLOSURE

This disclosure relates generally to communication protocols and, more particularly, to methods and apparatus to implement Compute Express Link (CXL) over Universal Serial Bus (USB)-C.

### BACKGROUND

In recent years, electronic devices have increased in number, variety, and complexity. Many industry members seek to connect and coordinate a diverse range of devices by implementing the devices with standardized connection systems, ports and/or plugs.

USB-C is a connection system that is implemented across a variety of devices. USB-C has risen in popularity for a number of reasons, including performance (e.g., data transfer and power delivery) and form factor.

### BRIEF DESCRIPTION OF THE DRAWINGS

FIG. 1A illustrates an example CXL over USB-C implementation in a first connection mode.

FIG. 1B illustrates an example CXL over USB-C implementation in a second connection mode.

FIG. 2 is a first block diagram of an example environment in which a System on a Chip (SoC) may operate to implement CXL over USB-C using the first connection mode of FIG. 1A.

FIG. 3 is a block diagram of an example environment in which the SoC of FIG. 2 may operate to implement CXL over USB-C using either the first connection mode of FIG. 1A or the second connection mode of FIG. 1B.

FIG. 4 is a block diagram of another example environment in which the SoC of FIG. 2 may operate to implement CXL over USB-C using the second connection mode of FIG. 1B.

FIG. 5A illustrates an example USB-4 packet structure which may be used to implement CXL over USB-C using the second connection mode of FIG. 1B.

FIG. 5B illustrates an example protocol definition field which may be used to implement CXL over USB-C using the second connection mode of FIG. 1B.

FIG. 6 is a flowchart representative of example machine-readable instructions and/or example operations that may be executed, instantiated, and/or performed by example programmable circuitry to implement an example discovery and entry into the first connection mode of CXL over USB-C of FIG. 1A.

FIG. 7 is a flowchart representative of example machine-readable instructions and/or example operations that may be executed, instantiated, and/or performed by example programmable circuitry to implement an example discovery and entry into the second connection mode of CXL over USB-C of FIG. 1B.

FIG. 8 is a block diagram of an example processing platform including programmable circuitry structured to execute, instantiate, and/or perform the example machine-readable instructions and/or perform the example operations of FIGS. 6 and 7 to implement the host systems 200 and 400 of FIGS. 2, 3, and 4.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine-readable instructions of FIGS. 6 and 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily scaled.

### DETAILED DESCRIPTION

Devices with USB-C connection systems may implement any number of past, present, and/or future communication protocols. For example, devices with a USB-C port support USB 3.2, a protocol released by the USB Implementers Forum (USB-IF), by default. The USB 3.2 Specification, Revision 1.1, published June 2022, is one example of documentation describing the USB3.2 protocol.

In some examples, USB 3.2 is referred to as a native mode for USB-C. USB-C enabled devices may also support a number of alternate past, present, and/or future protocols. For example, some USB-C enabled devices support protocols Display Port, a video interface protocol used by many graphics applications. The DisplayPort 2.1 specification, published Oct. 17, 2022 by the Video Electronics Standards Association (VESA), is one example of documentation describing the Display Port protocol.

Some USB-C enabled devices support USB-4, an architecture protocol that enables single, high-speed link with multiple hardware endpoints. The USB4 V2 Specification, published June 2023 by the USB-IF, is an example of documentation describing the USB4 protocol). Some USB-C enabled devices support Thunderbolt, a hardware interface protocol to multiplex multiple data signals between PCIe and DisplayPort devices. The Thunderbolt 4 (TBT4) Specification, published in July 2020 by Intel® and Apple®, is one example of documentation describing the Thunderbolt protocol.

Some USB-C enabled devices support Peripheral Component Interconnect Express (PCIE), a set of high-speed serial computer expansion bus standards. The PCI Express Base Revision 6.0.1, Version 1.0 Specification, published on Sep. 13, 2022, by the PCI Special Interest Group (PCI-SIG), is one example of documentation describing the PCIE protocol. Furthermore, some USB-C enabled devices support protocols other than those referenced in the foregoing examples.

PCIE refers to a group of protocols that each: (a) are designed for particular applications, and (b) implement the PCI-SIG standards. One such flavor of PCIE is Compute Express Link (CXL). CXL is built on top of the PCIE protocols to enable high speed processor-to-accelerator device communications and high-speed processor-to-device memory expansion connections. The CXL 3.0 Specification, published on Aug. 2, 2022, by the CXL Consortium, is one example of documentation describing the CXL protocol.

CXL enabled devices currently implement the CXL protocol across a PCIE connector slot. Generally, PCIE connector slots are implemented as an internal linkage in which a motherboard connects to a daughter board (e.g., a PCIE card). While some devices communicate using other types of PCIE protocols over USB-C, such devices cannot currently use the USB-C port to communicate using CXL.

Example methods, apparatus, and systems disclosed herein use the USB-C to communicate using the CXL protocol. An example device may use either a first example connection mode or a second example connection mode to communicate CXL over USB-C. In the first example connection mode, CXL is used as an alternate protocol (instead of a USB-IF defined protocol). To implement the first connection mode, CXL control circuitry is connected to USB-C physical layer (PHY) circuitry, and data is exchanged over General Purpose Input Output (GPIO) or Inter-Integrated Circuit (I2C) pins within a host system. In the second example connection mode, CXL control circuitry connects to USB control circuitry and CXL packets are tunneled into USB packets. Using either of these example modes enable devices to communicate using CXL over a USB-C port, thereby supporting additional applications that are not supported by other USB-C devices. For example, CXL over USB-C enables heterogeneous computing using disaggregated resources. Examples of such resources include storage memory or accelerators (which may be spread across many servers while provisioning coherent global access among all servers connected over the network).

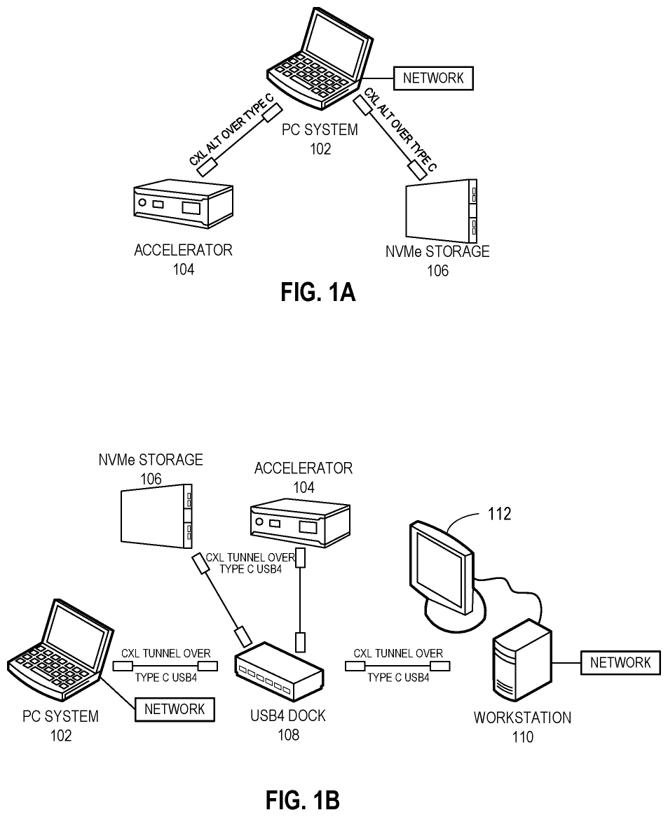

FIG. 1A illustrates an example of CXL over USB-C implemented in a first connection mode. FIG. 1A includes an example Personal Computer (PC) system 102, an example accelerator 104, and example nonvolatile memory express (NVMe) storage 106.

The PC system 102 is a low-cost device (e.g., a laptop). Accordingly, the PC system 102 has limited on-board memory (e.g., related to, for example, a server). The PC system 102 includes programmable circuitry (e.g., a Central Processor Unit (CPU)) that is limited in scope (e.g., related to, for example, a server). For instance, the PC system 102 may be unable to perform large amounts of computations in a time efficient manner as compared to, for example, a server. The PC system 102 includes a USB-C port but may be otherwise limited in the types of ports available to connect to peripheral devices.

The accelerator 104 of this example is a device that includes programmable circuitry. In the example, the accelerator 104 is implemented with a different type of programmable circuitry than the PC system 102 and/or includes different hardware components than the PC system 102. As a result, the accelerator 104 of this example is able to execute instructions and/or perform some operations more efficiently than the PC system 102. In some examples, the accelerator 104 performs operations based on instructions provided by the PC system 102. In some examples, the PC system 102 offloads tasks to the accelerator 104 so the PC system 102 can perform other tasks while the accelerator 104 attends to the offloaded tasks. The accelerator 104 returns the result(s) of the off-loaded tasks to the PC system 102 for further processing.

The accelerator 104 may be implemented by any type of programmable circuitry. Examples of programmable circuitry include, but are not limited to, programmable microprocessors, Field Programmable Gate Arrays (FPGAs) that may instantiate instructions, CPUs, Graphics Processor Units (GPUs), Digital Signal Processors (DSPs), XPUs, or microcontrollers and/or integrated circuits such as Application Specific Integrated Circuits (ASICs).

The nonvolatile memory express (NVMe) storage 106 refers to a memory device that implements the NVMe protocol published by the NVM Express Work Group. The NVMe is a storage access and transport protocol for flash memory and solid-state drives (SSDs). The NVMe protocol is an example implementation of a protocol built using the PCIe standard. While the example of FIG. 1 uses NVMe storage 106, other examples may additionally or alternatively use other types of storage (volatile and/or non-volatile).

The PC system 102, the accelerator 104, and the NVMe storage 106 of this example are all separate devices that may have been designed and/or manufactured independently of one another. By enabling CXL over USB-C as disclosed herein, the PC system 102 can hot-plug with both the accelerator 104 and the NVMe storage 106 (e.g., connect to the peripheral devices without turning the PC system 102 off). Accordingly, an individual can upgrade the functionality of the PC system 102 on a temporary, as-needed basis, thereby enabling a variety of applications (e.g., high performance computing, AI applications, etc.) with an inexpensive device.

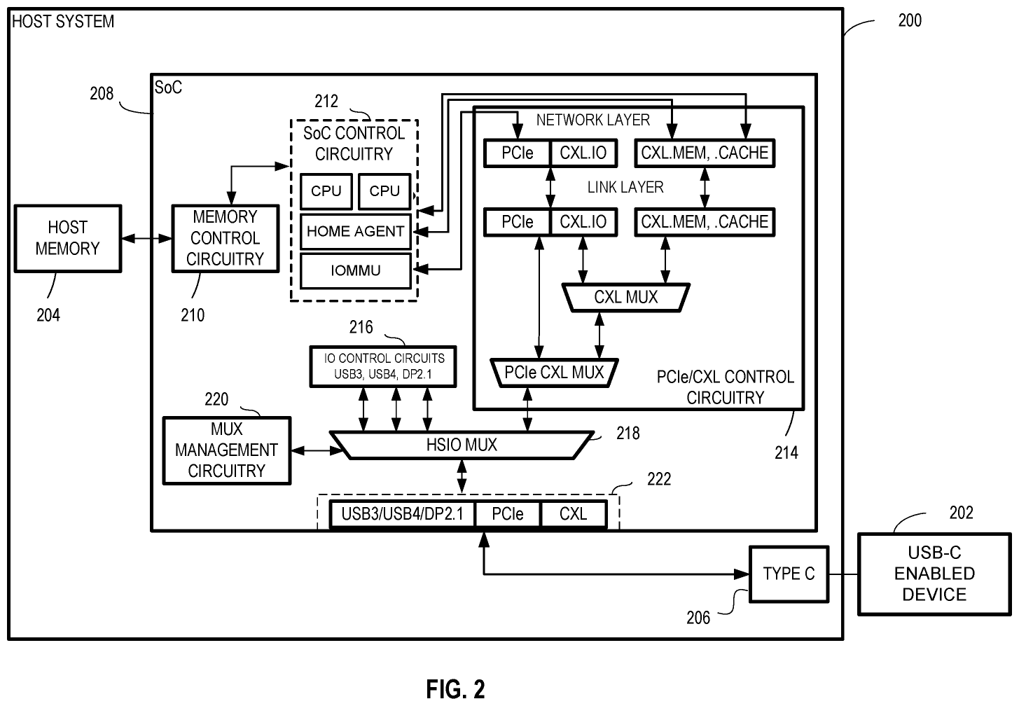

The example of FIG. 1A implements CXL over USB-C using a first connection mode as described in connection with teachings of this disclosure. In the first connection mode, the CXL protocol complies with the PCIe standard but is otherwise implemented as a standalone protocol (e.g., separately from other USB-C protocols such as, for example, USB 3.2, USB 4, DisplayPort 2.1, etc.). In some examples, the first connection mode is referred to as an alternate connection mode. In some examples, the first connection mode is referred to as CXL mode because a PCIe/CXL controller connects directly to physical layer circuitry without any tunneling. The first connection mode is discussed further in connection with FIG. 2.

FIG. 1B illustrates an example CXL over USB-C implementation in a second connection mode. FIG. 1B includes the example PC system 102, the example accelerator 104, and the example NVMe storage 106 of FIG. 1A. It also includes an example USB-4 dock 108, an example workstation 110, and an example display 112.

The USB-4 dock 108 of this example connects to each of the PC system 102, the accelerator 104, the NVMe storage 106, and the workstation 110 using a USB-C port. The USB-4 dock 108 also enables the PC system 102, the accelerator 104, the NVMe storage 106, and the workstation 110 to communicate with one another using, for example, the Thunderbolt or USB-4 protocol. In particular, the PC system 102, the accelerator 104, the NVMe storage 106, and the workstation 110 of this example exchange data formatted as CXL packets within USB packets (e.g., USB-4 packets).

Because they are connected to the USB-4 dock 108, both the PC system 102 and the workstation 110 can utilize the accelerator 104 and the NVMe storage 106. Advantageously, the use of USB-4 to implement CXL over USB-C can enable a peer-to-peer network in which a small enterprise or a home system can mimic the functionality of a large data center.

The example of FIG. 1B implements CXL over USB-C using a second connection mode as described in connection with teachings of this disclosure. In the second connection mode, the CXL protocol is tunneled into/implemented within the USB 4 protocol. In some examples, the second connection mode is referred to as a tunnel connection mode.

Systems that implement CXL over USB-C as described in teachings of this disclosure may exhibit several advantages over other connection systems. For example, as described in FIGS. 1A and 1B, a CXL over USB-C ecosystem is suited for single host CXL based standalone accelerators, memory expansion or multi host small network workgroup for disaggregated heterogenous computing or real time low latency computing at the edge. CXL accelerators and memory expansion devices with USB-C ports can hot plug to a mobile notebook, desktop host system or small work group networked systems for AI, vision processing, sensor, graphics, and/or smart storage edge applications. Multiple CXL accelerators and storage can be connected over multiple USB-C ports of a mobile, laptop or automobile system to run time critical 5G and/or sensor real time application tasks.

Additionally, CXL over USB-C can enable thinner mobile device form factors by reducing (e.g., removing) the need for additional ports (e.g., PCIe cards) inside the mobile device. In some examples, the USB-C port on a host can detect and support CXL/USB-4/TBT4/USB3.2/DP2.1 devices with a universal cable, reducing PCB footprint, cost, and distributed power dissipation. Advantageously, CXL over USB-C can reduce the base cost of a host system, reduce system thermal design power (TDP), simplify the Build of Materials (BOM) for a host system, and/or enable slim form factors.

In some examples, CXL over USB-C systems disclosed herein enable end users to dynamically attach and configure CXL HW to the system to meet application specific needs. In some such examples, CXL devices and switches can be hot plug connected to host as a USB-C CXL dock based on a specific application requirement. For example, mobile devices, notebooks or desktop systems can be dynamically hot plug connected and configured with CXL AI accelerators, smart storage extension, graphics, and sensor processing devices for edge applications. In some examples, USB-C CXL port can also enable small scale point-to-point applications such as host to GPU gaming, accelerators for signal processing software, imaging, and/or other math intensive workloads.

In some examples, CXL over USB-C systems disclosed herein enable CXL storage and accelerators to connect to a TBT-USB-4 interdomain tree network by tunneling CXL protocol over TBT-USB-4 interdomain for disaggregated heterogenous edge computing, memory sharing and/or pooling. In some examples, CXL traffic can also be tunneled over TBT-USB-4 concurrently with USB3, DP2.1, PCIe traffic to support a wide variety of data transfer applications.

FIG. 2 is a block diagram of an example implementation of a peripheral SoC to implement USB-C using the first connection mode. The peripheral SoC of FIG. 2 may be instantiated (e.g., creating an instance of, bring into being for any length of time, materialize, implement, etc.) by programmable circuitry such as a Central Processor Unit (CPU) executing first instructions. Additionally or alternatively, the peripheral SoC of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example of FIG. 2 includes an example host system 200 and a USB-C enabled device 202. The host system 200 includes example host memory 204, an example USB-C port 206, and an example SoC 208. The SoC 208 includes example memory control circuitry 210, example SoC control circuitry 212, example PCIe/CXL control circuitry 214, example IO control circuits 216, an example High Speed Input Output (HSIO) multiplexer 218, example multiplexer management circuitry 220, and example physical layer (PHY) circuitry 222.

The host system 200 (e.g., the PC system 102 of FIGS. 1A and 1B) of this example implements the first connection mode of CXL over USB-C connection in accordance with teachings of this disclosure. Similarly, the USB-C enabled device 202 (e.g., the accelerator 104, the NVMe storage 106, etc. of FIGS. 1A and 1B) of this example is an external device that connects to the host system 200 using CXL over USB-C.

The host memory 204 may be implemented as any type of memory. For example, the host memory 204 may be a volatile memory or a non-volatile memory. The volatile memory may be implemented by Synchronous Dynamic Random Access Memory (SDRAM), Dynamic Random Access Memory (DRAM), and/or any other type of RAM device. The non-volatile memory may be implemented by flash memory and/or any other desired type of memory device.

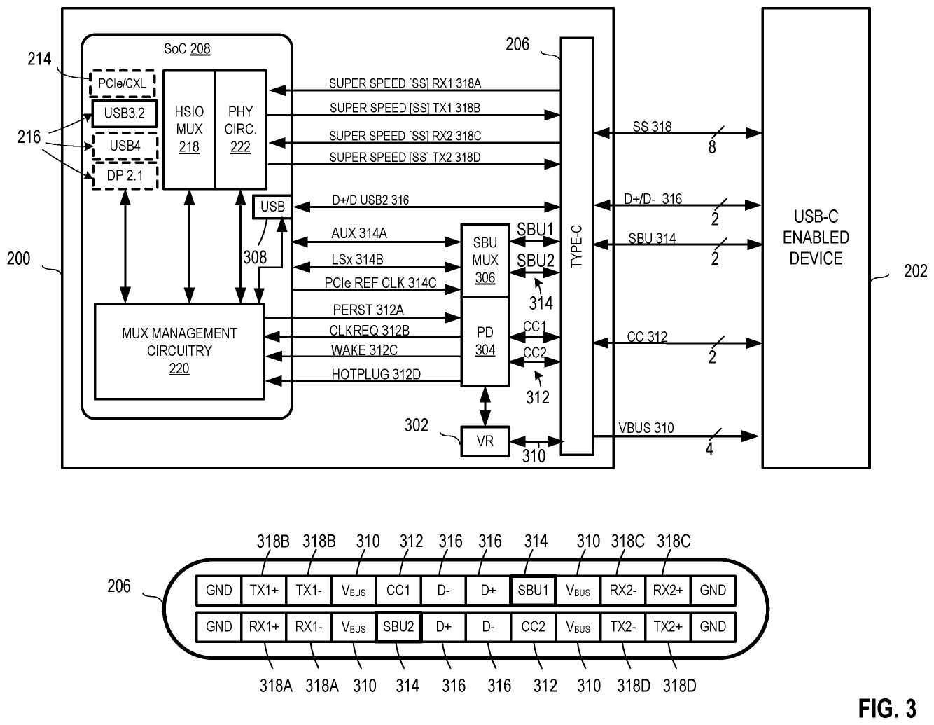

The USB-C port 206 of this example includes a set of pins that are organized according to the USB-C standard. In some examples, the pins within the USB-C port 206 are referred to as terminals, endpoints, etc. The standardized USB-C pin layout is discussed further in connection with FIG. 3.

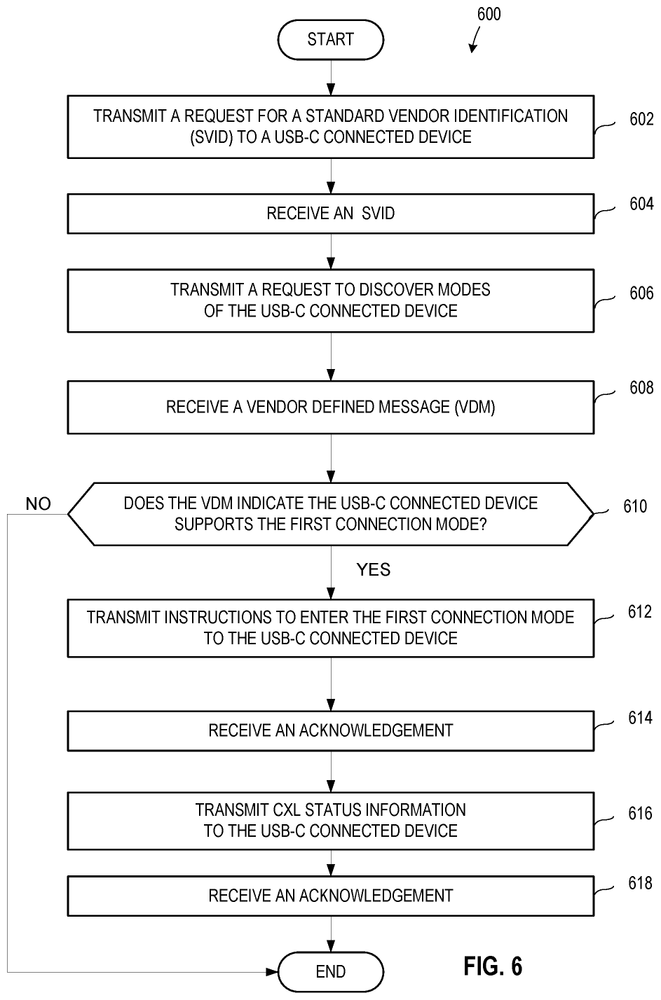

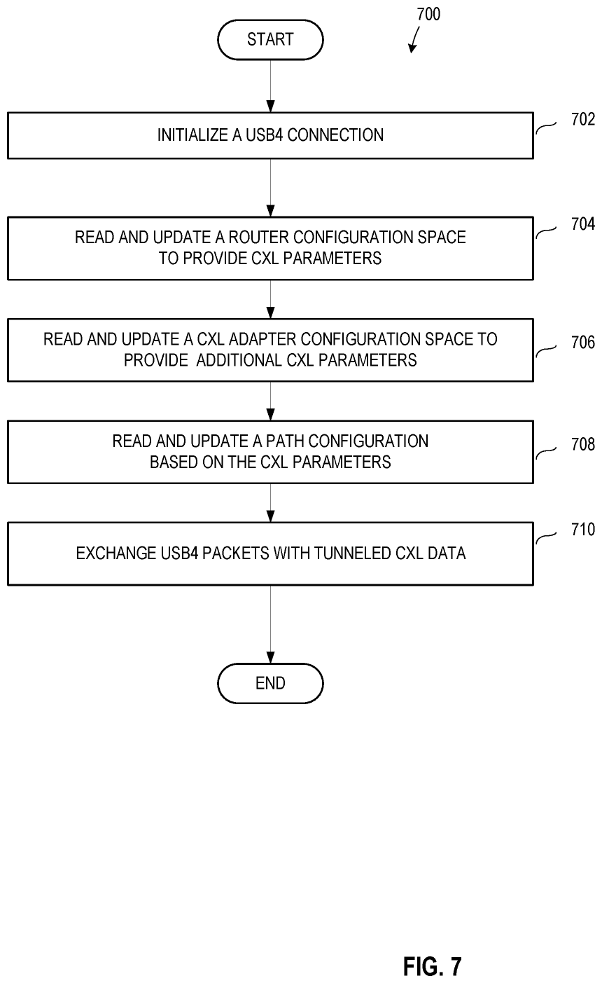

The SoC 208 of the example of FIG. 2 implements the first connection mode of CXL over USB-C in accordance with teachings of this disclosure. Within the SoC 208, the memory control circuitry 210 reads data from and writes data to the host memory 204. The data may include a message transmitted to or received from the USB-C enabled device 202. In some examples, the memory control circuitry 210 performs read and write operations based on instructions from the SoC control circuitry 212. In some examples, the SoC 208 is instantiated by programmable circuitry executing SoC instructions and/or configured to perform operations such as those represented by the flowchart(s) of FIGS. 6 and 7.

Within the SoC 208, the SoC control circuitry 212 coordinates and manages the operations of other components within the SoC 208. For example, the SoC control circuitry 212 may decide which messages to send to the USB-C enabled device 202, which control circuits to connect to the PHY circuitry 222, etc. In some examples, the SoC control circuitry 212 performs some or all of the foregoing operations based on instructions from a host processor within the host system 200. In the example of FIG. 2, the SoC control circuitry 212 includes two CPU cores, home agent circuitry to maintain cache coherency by providing a mapping between the address space of the host memory 204 and the respective CPU cores, and Input-Output Memory Management Unit (IOMMU) circuitry to connect external memory components (e.g., the NVMe storage 106) to the host memory 204.

The SoC control circuitry 212 may additionally include root complex circuitry to exchange data between the PCIe modules of the PCIe/CXL control circuitry 214 and the host memory 204 via the IOMMU. However, link traffic transported by the root complex circuitry does not support cache coherency and other features that are present in the CXL protocol. Accordingly, the SoC control circuitry 212 additionally includes CPU fabric circuitry to connect the CXL.cache protocol circuitry and the CXL.memory protocol circuitry of the PCIe/CXL control circuitry 214 directly to the home agent circuitry. In other examples, the SoC control circuitry 212 includes different types and configurations of programmable circuitry and control circuitry and/or instructions. In some examples, the SoC control circuitry 212 is instantiated by programmable circuitry executing instructions and/or configured to perform operations such as those represented by the flowchart(s) of FIGS. 6 and 7.

Within the SoC 208, the PCIe/CXL control circuitry 214 of the example of FIG. 2 is a standalone unit of logic circuitry which may be implemented by an integrated circuit (IC). In some examples, the PCIe/CXL control circuitry 214 is referred to as an intellectual property (IP) core. In some examples, the PCIe/CXL control circuitry 214 receives instructions from the SoC control circuitry 212 to form CXL messages. The PCIe/CXL control circuitry 214 of this example may additionally or alternatively receive a PCIE and/or CXL compliant message from the USB-C enabled device 202 and convert the message into a format interpretable by the SoC control circuitry 212.

The PCIe/CXL control circuitry 214 of the example of FIG. 2 implements the network layer and the link layer of Open Systems Interconnection (OSI) model using either a general PCIe protocol or the CXL protocol. Accordingly, the PCIe/CXL control circuitry 214 of this example includes PCIe network circuitry, CXL network circuitry, PCIe layer circuitry, CXL layer circuitry, and a multiplexer to choose between the CXL protocol or a different PCIe protocol. The PCIe/CXL control circuitry 214 also includes a CXL specific multiplexer to choose whether to connect to: (a) CXL.io protocol circuitry, or (b) CXL.memory protocol circuitry and a CXL.cache protocol circuitry, when CXL is implemented. In some examples, the CXL.IO protocol circuitry is connected to the root complex circuitry of the SoC control circuitry 212, the CXL.memory protocol circuitry is connected to the CPU fabric circuitry of the SoC control circuitry 212, and the CXL.cache protocol circuitry is connected to the CPU fabric circuitry of the SoC control circuitry 212. The foregoing connections enable the CXL.memory protocol circuitry to achieve low latency and the CXL.cache protocol circuitry to achieve cache coherency.

In some examples, the PCIe/CXL control circuitry 214 is instantiated by programmable circuitry executing instructions and/or configured to perform operations such as those represented by the flowchart(s) of FIGS. 6 and 7.

The IO control circuits 216 of this example are implemented by one or more control circuits that respectively implement the network and link layers of a USCB-C supported protocol other than PCIe or CXL. In the example of FIG. 2, the IO control circuits 216 are implemented by a USB 3.2 control circuit, a USB 4 control circuit, and a DisplayPort 2.1 control circuit. In other examples, the IO control circuits 216 may additionally or alternatively include other protocols and control circuits.

The HSIO multiplexer 218 of this example connects either the PCIe/CXL control circuitry 214 or one of the IO control circuits 216 to the PHY circuitry 222. The HSIO multiplexer 218 determines which IP core to connect to the PHY circuitry 222 based on the multiplexer management circuitry 220. The multiplexer management circuitry 220 is discussed further in connection with FIG. 3.

In the example of FIG. 2, the PHY circuitry 222 is a physical connector that implements the physical layer of the OSI model by electrically connecting the SoC 208 to the USB-C port 206. The PHY circuitry 222 may form different electronic connections based on the protocol output by the HSIO multiplexer 218. Accordingly, in FIG. 2, the PHY circuitry 222 can be configured to support USB 3.2, USB 4, DisplayPort 2.1, PCIe, and/or CXL. The PHY circuitry 222 of this example may include any number of electronic components (resistors, capacitors, etc.) to support transmission and reception of data. Accordingly, the example PHY circuitry 222 may include different electrical devices than other USB-PHY layers in order to support voltages present in the CXL messages.

The PCIe/CXL control circuitry 214 of the example of FIG. 2 is a standalone IC core that may be designed and manufactured independently of the host system 200 and/or the SoC 208. Other devices that implement the PCIe/CXL control circuitry 214 or similar control circuit(s) connect the control circuit to a PCIe card slot. As such, other devices are limited in their use of CXL to connect devices that connect with the wide, generally internal-facing, PCIe card slot. Similarly, other USB-C devices in the market only use the HSIO multiplexer 218 to choose between the IO control circuits 216.

Advantageously, the SoC 208 of FIG. 2 includes a physical connection between the PCIe/CXL control circuitry 214 and the USB-C port 206 via the HSIO multiplexer 218 and the PHY circuitry 222. In some examples, the connection between the PCIe/CXL control circuitry 214 and the PHY circuitry 222 implements the Physical Interface for PCI Express (PIPE) specification defined by Intel®. Because the PHY circuitry 222 and the HSIO multiplexer 218 of the illustrated example are configured to support a variety of protocols, connecting the PCIe/CXL control circuitry 214 seamlessly enables the CXL protocol over the USB-C port 206.

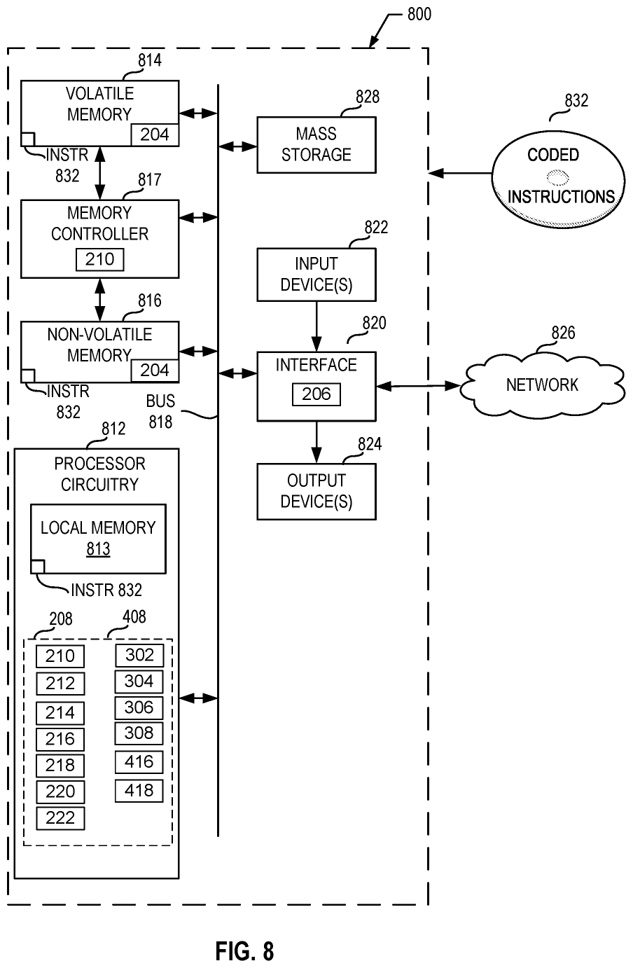

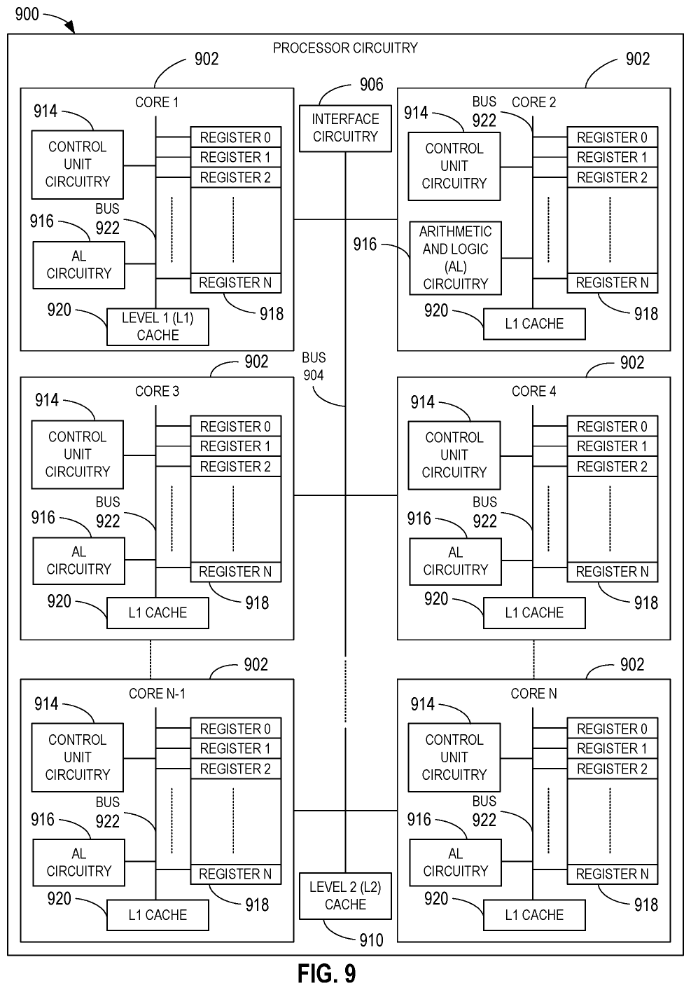

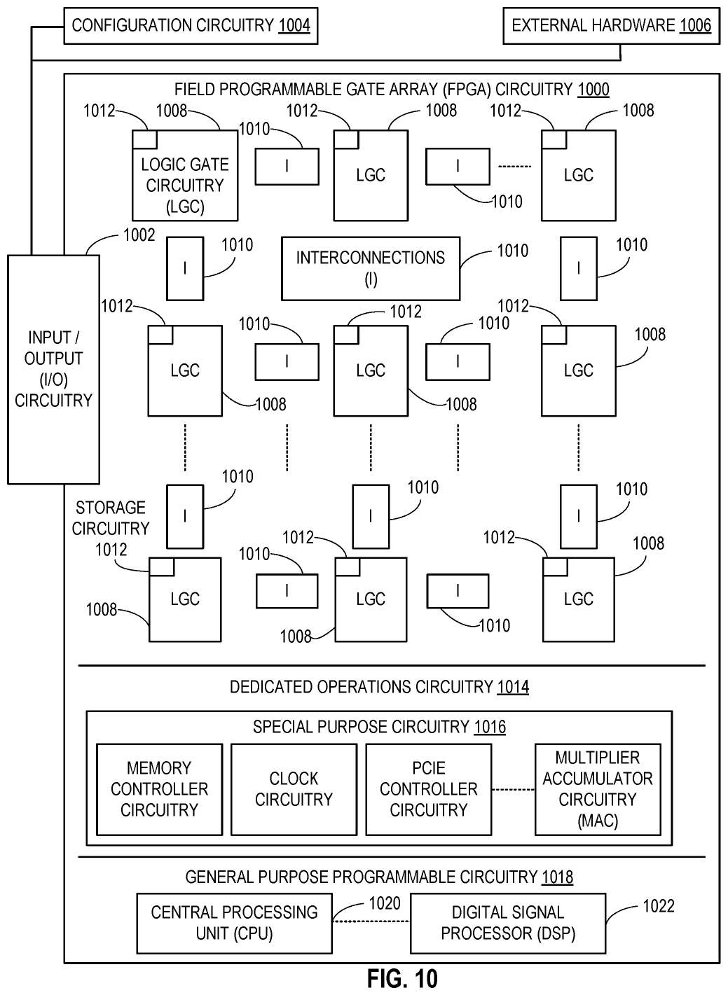

In some examples, the host system 200 includes means for entering a first connection mode. For example, the means for entering a first connection mode may be implemented by multiplexer management circuitry 220. In some examples, the multiplexer management circuitry 220 may be instantiated by programmable circuitry such as the example programmable circuitry 812 of FIG. 8. For instance, the multiplexer management circuitry 220 may be instantiated by the example microprocessor 900 of FIG. 9 executing machine executable instructions such as those implemented by at least blocks 602-608, 612, 616 of FIG. 6. In some examples, the multiplexer management circuitry 220 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the multiplexer management circuitry 220 may be instantiated by any other combination of hardware, software, and/or firmware. For example, the multiplexer management circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

FIG. 3 is a block diagram of an example environment of FIG. 2 in which the example host system 200 may operate to implement CXL over USB-C using either the first connection mode or second connection mode disclosed herein. FIG. 3 includes the host system 200 and the USB-C enabled device 202 of FIG. 2. The host system 200 includes the USB-C port 206 and the SoC 208 as shown in FIG. 2. In the example of FIG. 3, the host system 200 also includes example Voltage Regulator (VR) circuitry 302, power delivery (PD) circuitry 304, and example Side Band Use (SBU) multiplexer 306. The example SoC 208 includes the PCIe/CXL control circuitry 214, the other IO control circuits 216, the HSIO multiplexer 218, the multiplexer management circuitry 220, the PHY circuitry 222 of FIG. 2. The SoC 208 in the illustrative example of FIG. 3 also includes USB2 circuitry 308. FIG. 3 further includes example VBUS pins 310, example communication channel (CC) pins 312, example SBU pins 314, example USB2 data (D) pins 316, and example super speed (SS) pins 318.

As described above in connection to FIG. 2, the host system 200 implements CXL over USB-C with the first connection mode in accordance with teachings of this disclosure. Similarly, the USB-C enabled device 202 refers to a device (e.g., the accelerator 104, the NVMe storage 106, etc.) that connects to the host system 200 using CXL over USB-C in the first connection mode. In some examples, the USB-C enabled device 202 implements an instance of the USB-C port 206, the SoC 208, the VR circuitry 302, the PD circuitry 304, and the SBU multiplexer 306 in order to facilitate the exchange of CXL data over USB-C as described in teachings of this disclosure.

The VR circuitry 302 in this example provides power to the USB-enabled device 202 through the VBUS pins 310. Accordingly, in the example of FIG. 3, the host system 200 may be considered a power source and the USB-enabled device 202 may be referred to as a power sink. While the VR circuitry 302 may implement a default voltage and amperage (e.g., a default amount of power) across the VBUS pins 310, the VR circuitry 302 in the USB-enabled device 202 can negotiate with the VR circuitry 302 in the host system 200 to obtain a different voltage and/or current across the VBUS pins 310 by the help of CC pins 312.

The SoC 208 in the example of FIG. 3 is connected to PD circuitry 304, which uses the USB-C port 206 to send or receive power. In particular, the PD circuitry 304 of the host system 200 communicates with the PD circuitry of the USB-C enabled device 202 to determine which device will supply power (e.g., act as a source) and which device will consume power (e.g., act as a sink). In some examples described herein, the host system 200 acts as a source, so the PD circuitry 304 causes the VR circuitry 302 to provide power through the VBUS pin 310. In other examples, the host system 200 acts as a sink, so the PD circuitry 304: a) consumes power from the USB-C enabled device 202 and b) supplies power to the rest of the host system 200.

The PD circuitry 304 can also use the communication channel (CC) pins 312 to deliver data. In particular, the PD circuitry 304 causes the USB-C port 206 to transfer vendor defined messages (VDMs) using the CC pins 312. In some examples, VDMs allow designers and manufacturers of USB-C enabled devices to exchange information defined by USB-C connector and PD supported protocols. For example, the SoC 208 may implement the DisplayPort 2.1 protocol using VDMs that are transmitted over the CC pins 312.

Advantageously, the PD circuitry 304 uses VDMs on CC pins 312 to exchange protocols to determine a communication mode (e.g., whether PCIe, CXL, USB3.2, DP2.1, USB4, or TBT 4, etc., will be used to communicate with the USB-C enabled device 202). When in CXL mode (e.g, the first connection mode as described in accordance with the teachings of this disclosure), the PD circuitry 304 may use the CC pins 312 to transfer an example PCIe Reset (PERST) signal 312A, an example CLKREQ signal 312B, an example wake signal 312C, and/or the example hot plug signals 312D. The foregoing signals are defined transmitted in VDMs that are defined by PD 3.1 (a Power Delivery specification published by PCI-SIG). The foregoing signals are also used to implement PCIe protocols, including specific implementations of PCIe such as CXL. The PERST signal 312A, the CLKREQ signal 312B, the wake signal 312C, and/or the hot plug signals 312D may be considered in-band signals because they are delivered over CC pins 312 that include power and/or data protocol. The PD circuitry 304 of this example transmits VDMs with PCIe signals to the SoC 208 over either GPIO pins (as shown in FIG. 3) or over an I2C connection between the PD circuitry 304 and the SoC 208, thereby enabling end to end CXL communication.

The PD circuitry 304 of this example provides the foregoing PCIe signals across two separate messages. The first message is described in Table 1:

| Bit(s) | Description | Values |
|---|---|---|
| 31:24 | Mode | 0x01 = Microsoft PCI Express First connection |
| | Identification | mode |
| | | 0x02 = CXL First connection mode |
| 23:16 | Supported Pin | Bit 0: USB Safe State (SSRX, SSTX, SBU Hi-Z) |
| | Assignments | Bit 1: 1-Lane PCI Express |
| | | Bit 2: 1-Lane PCI Express with USB 3.1 |
| | | Bit 3: 2-Lane PCI Express |
| | | Bit 7-4: Reserved = 0, ignore |
| 15:3 | RESERVED | 0 |
| 2:1 | PCI Express | Port type: |
| | Port Type | 00b: PCI Express Endpoint UFP |
| | | 01b: PCI Express Switch UFP |
| | | 10b: PCI Express Switch DFP |
| | | 11b: PCI Express Root Complex DFP |
| 0 | USB2 Data | 0: No USB 2.0 function |
| | Capable | 1: USB 2.0 Data Capable in all Pin Assignments |

In this example, Table 1 shows that the devices implemented in accordance with teachings of this disclosure may use the hexadecimal value 0x02 across bits 34:21 of the first message to indicate the device is operating in the first connection mode (e.g., the alternate connection mode for CXL over USB-C). That is, the first message indicates that a forthcoming second message will be formatted to provide CXL data. The second message is described in Table 2:

| Bit(s) | Description | Values |
|---|---|---|
| 31:20 | Field Change Mask | Set a bit to 1 when the corresponding field is |
| | | set with a value. |
| | | Bitmap: |
| | | Bit 0: CLKREQ |
| | | Bit1: WAKE |
| | | Bit2: PERST |
| | | Bit 3: PRSNT2 |
| | | Bit 4: USP_PERST# |
| | | Bit 5: USP_ATTN# |
| | | Bit 6: DSP ATTN# |
| | | Bits 10-7: Reserved |
| | | Bit 11: Pin Assignment |
| 19:16 | Current Pin | Discover Modes VDO |
| | Assignment | |
| 15:7 | RESERVED | 0 |
| 6 | DSP_ATTN# | Attention button indicates a request to the |
| | | host for a managed hot remove of the switch |
| 5 | USP_ATTN# | Attention button indicates a request to the |
| | | host for a managed hot remove of the switch |
| 4 | USP_PERST# | PCIe reset provides a fundamental reset to a |
| | | virtual CXL Switch (VCS) |
| 3 | PRSNT2 | PCI Express device-present signal |
| 2 | PERST | PCI Express Reset signal |
| 1 | WAKE | PCI Express Wake signal |
| 0 | CLKREQ | PCI Express Reference Clock Request signal |

Table 2 shows that the devices implemented in accordance with teachings of this disclosure may use bits 4, 5, and 6 within the second VDM to indicate: (a) a request to the host for a managed hot remove of the switch, (b) a request to the host for a managed hot remove of the switch, and (c) a fundamental reset to virtual CXL Switch (VCS). Advantageously, the SoC 208 can use information from Table 2 in combination with the other information provided in PCIe enabled VDMs to provide CXL messages across the USB-C port 206. In this example, PCIE signals in the VDM of Table 2 include the PERST signal 312A, the CLKREQ signal 312B, and the wake signal 312C.

The SBU pins 314 in the example of FIG. 3 are used to transmit signals other than those included in the default USB 3.2 protocol across the USB-C port 206. For example, the SBU multiplexer 306 may use the two SBU pins 314 to implement an auxiliary (AUX) channel 314A when in DP2.1 mode, the LSx signal 314B when in USB4-TBT4 mode, or the PCIe REF CLK signal 314C when in CXL mode. The PD circuitry 304 uses protocol exchange over the CC pins 312 to determine if the USB-C enabled device 202 is in CXL mode, DP2.1 mode, USB3.2 mode, or TBT4-USB4 mode. Based on the determination, the PD circuitry 304 then causes the SBU multiplexer 306 to route to the appropriate signal on the SBU pins 314 to the corresponding control circuit. For example, if the USB-C enabled device 202 is in DP.21 mode, the SBU multiplexer 306 routes the AUX channel 314A data by connecting the SBU pins 314 to the DP 2.1 control circuit within the IO control circuits 216. Similarly, if the USB-C enabled device 202 is in USB4-TBT mode, the multiplexer routes the LSx signal 314B by connecting the SBU 314 pins to the USB4 control circuit within the IO control circuits 216.

If the USB-C enabled device 202 is in CXL mode, the USB-C enabled device 202 may request a PCIe reference clock, using a VDM sent by PD circuitry 304 over CC pins 312. To request the PCIe reference clock, the USB-C enabled device enables the bits representative of the CLKREQ signal 312B, as shown in Table 2. Within the host system 200, the PD circuitry 304 forwards the request to the multiplexer management circuitry 220 using either GPIO or I2C communication. In turn, the multiplexer management circuitry 220 triggers the PCIe/CXL control circuitry 214 to generate the PCIe REF CLK signal 314C. The PCIe REF CLK signal 314C is a PCI-SIG defined differential signal that provides the requested clock signal to the USB-C enabled device 202. Because the host system 200 in the foregoing example is also in CXL mode the SBU multiplexer 306 causes the SBU pins 314 to transmit the PCIe REF CLK signal 314C.

The D+/D− pins 316 implement a link for a legacy USB2 protocol. In the example of FIG. 3, the D+/D− pins 316 are used when the SS pins 318 fail to successfully function using the USB 3.2 or USB 4 protocol. In such situations, the host system 200 may downgrade to the lower speed USB2 mode that is implemented on the D+/D− pins 316.

The SS pins 318 in the example of FIG. 3 provide high speed differential signals used to transmit and/or receive data with the USB-C enabled device 202. The data sent across the SS pins 318 may be implemented in any of the PCIE, CXL, USB 3.2, USB 4, or DisplayPort 2.1 protocols depending on the connected control circuit. The eight SS pins 318 implement two Tx positive signals, two Tx negative signals, two Rx positive signals, and two Rx negative signals, thus contributing two bidirectional links.

The multiplexer management circuitry 220 in the example of FIG. 3 connects the PCIe/CXL control circuitry 214 or one of the IO control circuits 216 to the PHY circuitry 222 via the HSIO multiplexer 218. In some examples, the multiplexer management circuitry 220 determines which control circuit should connect to the PHY circuitry 222 based on the protocol format of signals provided on the CC pins 312. For example, suppose the PD circuitry 304 determines, using VDM protocol exchanges with the USB-C enabled device 202 on CC pins 312, that the USB-C enabled device 202 is in CXL mode (e.g, the first connection mode as described in accordance with the teachings of this disclosure). In such an example, the multiplexer management circuitry 220 would connect the PCIe/CXL control circuitry 214 to the PHY circuitry 222 so that the SoC 208 can transmit CXL messages to the USB-C enabled device 202. In a different example, the PD circuitry 304 and the CC pins 312 may be used to provide DisplayPort 2.1 data packets, and the multiplexer management circuitry 220 connects the DisplayPort 2.1 control circuit of the IO control circuits 216 to the PHY circuitry 222.

In some applications, the electrical bandwidth in a USB-C ecosystem can lead to constraints in CXL. For example, the link loss budget and re-timers of USB-C allow a 20 gigabit per second (Gbps) non-return-to-zero (NRZ) data rate on an end-to-end channel. With two bi-directional lanes available on the USB-C port 206, the aggregate bandwidth is approximately 40 Gbps. At 40 Gbps, a CXL link can be achieved for standalone alone peer to peer, edge compute and small office workgroup applications using both the first connection mode and the second connection mode disclosed herein.

Generally, USB-C PHY circuits are capable of driving and recovering USB3.2, DP2.1 and thunderbolt (TBT) USB-4 NRZ data rates over a Type C cable. AC coupling capacitors used in a Type C connector may be implemented within the PCIe 176-265 nano-Farad (nF) range.

Advantageously, the PHY circuitry 222 drives and receives PCIe data rates up to Gen 4 at 16 Gigabits per second (Gbps) to achieve target CXL data rates. With two lanes on the USB-C port 206, the PHY circuitry 222 achieves an aggregate 32 Gbps bi-directional full duplex bandwidth.

In some examples, the host system 200 includes means for communicating over communication channel (CC) pins 312. For example, the means for communicating over CC pins may be implemented by PD circuitry 304. In some examples, the PD circuitry 304 may be instantiated by programmable circuitry such as the example programmable circuitry 812 of FIG. 8. For instance, the PD circuitry 304 may be instantiated by the example microprocessor 900 of FIG. 9 executing machine executable instructions such as those implemented by at least blocks 610, 614, 618 of FIG. 6. In some examples, the PD circuitry 304 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the PD circuitry 304 may be instantiated by any other combination of hardware, software, and/or firmware. For example, the PD circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

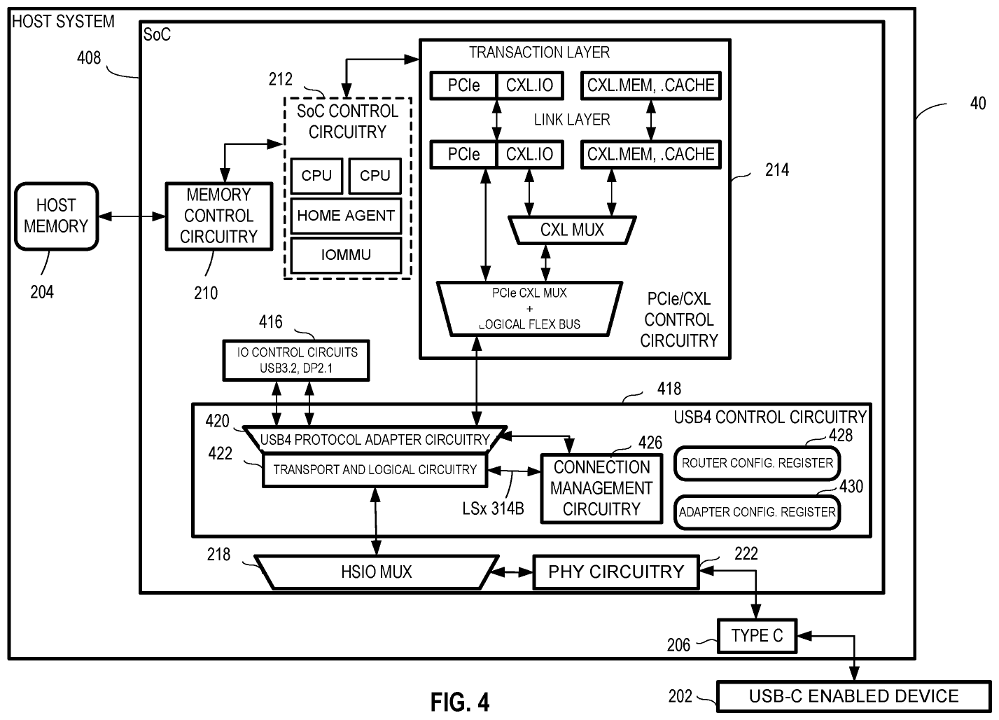

FIG. 4 is a block diagram of an example implementation of the SoC 208 to implement CXL over USB-C using the second connection mode of FIG. 1B. The example of FIG. 4 includes an example host system 400 and the USB-C enabled device 202 of FIG. 2. The host system 400 includes the example host memory 204, the example USB-C port 206, and an example SoC 408. The example SoC 408 includes the memory control circuitry 210, the SoC control circuitry 212, the PCIe/CXL control circuitry 214, the HSIO multiplexer 218, and the PHY circuitry 222 of FIG. 2. The example SoC 408 also includes example IO control circuits 416, and example USB4 control circuitry 418. The USB4 control circuitry 418 of this example includes example USB-4 protocol adapter circuitry 420, example transport and logical layer circuitry 422, example connection management circuitry 426, an example router configuration register 428, and an example adapter configuration register 430. In other examples, the USB4 control circuitry 418 implements different USB4 tunnel protocol(s).

The host system 400 of this example implements the second connection mode (e.g., CXL tunneled over USB-C) in accordance with teachings of this disclosure. In particular, the host system 400 of FIG. 4 is an example implementation of the host system 200 of FIG. 2 after: a) the PD circuitry 304 used the CC pins 312 to determine the USB-C enabled device 202 is in USB4-TBT mode, and b) the multiplexer management circuitry 220 has connected the USB4 control circuit of the IO control circuits 216 to the PHY circuitry 222 via the HSIO multiplexer 218. Accordingly, the example SoC 408 of FIG. 4 is an alternate representation of the example SoC 208 of FIGS. 2 and 3, and the example USB4 control circuitry 418 is a more detailed representation of the USB4 control circuit of the IO control circuits 216.

The IO control circuits 416 of the example of FIG. 4 refer to one or more control circuits that respectively implement the network and link layers of a USCB-C supported protocol other than PCIe, CXL, or USB-4. In the example block diagram of FIG. 4, the IO control circuits 416 refers to a USB 3.2, control circuit and a DisplayPort 2.1 control circuit. In other examples, the IO control circuits 416 may additionally or alternatively include other protocols and control circuits.

Within the USB4 control circuitry 418, the USB-4 protocol adapter circuitry 420 of this example connects either the PCIe/CXL control circuitry 214 or one of the IO control circuits 416 to the transport and logical layer circuitry 422. The USB-4 protocol adapter circuitry 420 may determine which IP core to connect to the transport and logical layer circuitry 422 based on instructions from software and/or firmware that implements the connection management circuitry 426. The connection management circuitry 426 configures the other modules of the USB4 control circuitry 418 based in part on the LSx signal 314B, which describes device speed and other configuration data of the USB-C enabled device 202. The LSx signal 314B is provided to the USB4 control circuitry 418 using the SBU pins 314 as described above in connection with FIG. 3. The connection management circuitry 426 is discussed further below.

Because the system is in USB4 mode, the USB-4 protocol adapter circuitry 420 within the host system 400 may be referred to as a host router (a term defined by and used within the USB4 protocol). Similarly, the USB-4 protocol adapter circuitry 420 within the USB-C enabled device 202 may be referred to as a device router (another term defined by and used within the USB4 protocol) when the USB-C enabled device 202 is in USB4 mode. In some examples, the USB4 control circuitry 418 is referred to as a USB-4 fabric.

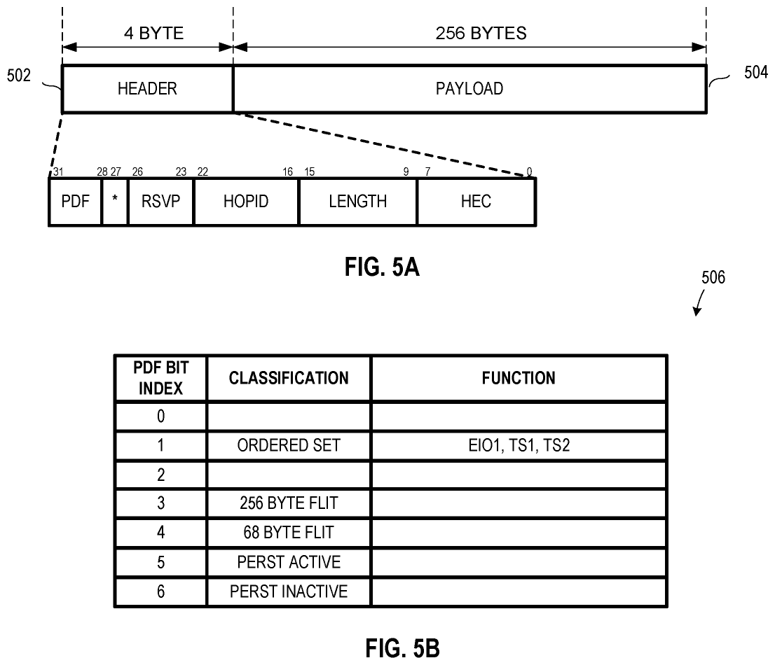

The USB-4 protocol adapter circuitry 420 of this example also adapts packets formatted in various USB-C supported protocols into the USB-4 protocol. That is, the USB-4 protocol adapter circuitry 420 can obtain PCIe or CXL packets and package the information to a USB-4 packet. In some examples, the packaging of CXL data into a USB-4 packet is referred to as tunneling. Accordingly, in some examples, the second connection mode disclosed herein is referred to as a tunnel connection mode. The formatting of a USB-4 with tunneled CXL data is discussed further in connection with FIGS. 5A and 5B.

The transport and logic layer circuitry 422 of this example converts packets from various control circuits 416 (e.g., DP2.1 adapter packets, USB3.2 adapter packets, PCIe adapter packets, and CXL adapter packets) into USB4 payload fragments. The transport and logic layer circuitry 422 also instructs the PHY circuitry 222 to transmit the USB4 payload fragments over the SS pins 318 of the USB-C port 206.

The USB-4v2 specification includes Pulse Amplitude Modulation 3 (PAM3) line encoding that enables IO data rate to scale up to 80 Gbps full duplex, and, in asynchronous mode, 120 Gbps downstream and 40 Gbps upstream. A CXL tunnel can use 80 Gbps full duplex bandwidth with USB-4v2 supporting host and device While both the CXL.cache protocol and the CXL.memory protocol can be tunneled in TBT—USB-4 mode, the CXL.cache has a stricter link latency timing requirement than CXL.memory usage.

Examples disclosed herein define an adapter interface that tunnels CXL messages into USB packets (e.g., USB-4 packets). The example of FIG. 4 shows the PCIe/CXL control circuitry 214 within the SoC 408 that connects to the USB4 control circuitry 418. In some examples, the host system 400 and the USB-C enabled device 202 have similar components and connections to enable the exchange of data in the second connection mode disclosed herein (e.g., tunneled CXL over USB-C). The USB-4 protocol adapter circuitry 420 may interface with a PCIe/CXL logical sub-block within the PCIe/CXL control circuitry 214 and support the interleave between CXL.io & CXL.memory/CXL.cache. The USB-4 protocol adapter circuitry 420 of this example determines when the PCIe or ALT CXL protocol is triggered and, accordingly, processes CXL packets to be encapsulated inside the USB packets (e.g., USB-4 packets) for tunnel.

Advantageously, to tunnel CXL packets into USB packets (e.g., USB-4 packets) the USB-4 protocol adapter circuitry 420 also implements an example PCIe-CXL adapter enumeration process in accordance with teachings of this disclosure. The example PCIe-CXL adapter enumeration process adds a PCIe-CXL type in the adapter configuration register 430 in the routers supporting CXL tunnel:
Downstream PCIe-CXL Adapter protocol id [Protocol ID: 0x10, Version: 0x1, Subtype: 0x3]
Upstream PCIe-CXL Adapter protocol id [Protocol ID: 0x10, Version: 0x1, Subtype: 0x4]ROUTE

The PCIe-CXL adapter enumeration process disclosed herein also adds: (a) the field ROUTER_CS_5 bit 22 CXL Tunnel On (CTO) in the router configuration register 428, (b) a Link Training and Status State Machine (LTSSM) in the adapter configuration register 430, and (c) a path enable field in the adapter configuration register 430.

In the example PCIe-CXL adapter enumeration process, the adapter configuration register 430 includes a detect state, a Flex bus, and a selection between 68 bytes and 256-bytes flit packet transport mode bits. As used above and herein, a flit refers to a unit amount of data when the message is transmitting in the link level of the OSI model.

In the example PCIe-CXL adapter enumeration process, a CXL device hot plug selects the flex bus by the end of PCIe-CXL training. In the Configuration.Lanenum Wait/Accept/Complete training stages, downstream CXL ports may exchange modified training sequence 1 (TS1), training sequence 2 (TS2) ordered sets to negotiate the entrance of the first connection mode disclosed herein (e.g., the alternate connection mode). After the negotiation, the CXL devices enter the first connection mode using either CXL.io or CXL.cache/CXL.mem protocols, and with either 68 bytes or 256 bytes flit packet transport. The example USB-4 protocol adapter circuitry 420 then stores the one or more of the foregoing parameters (e.g., protocol selection and/or flit packet size) in the PCIe-CXL Adapter conFIG LTSSM register status (or a similar register) described above. The register status may be based on the TS1 symbols exchanged during the link training and may describe properties of the link (e.g., CXL.io or CXL.mem/CXL.cache, 68 bytes or 256-bytes Flit, etc.) Following the example PCIe-CXL adapter enumeration process, the connection management circuitry 426 within the USB4 control circuitry 418 reads the status updated in the CXL adapter config register 430. The connection management circuitry 426 then uses the status to establish PCIe-CXL path and tunneling of CXL packets.

In some examples, the host system 400 includes means for communicating in a second connection mode. For example, the means for communicating in the second connection mode may be implemented by USB-4 protocol adapter circuitry 420. In some examples, the USB-4 protocol adapter circuitry 420 may be instantiated by programmable circuitry such as the example programmable circuitry 812 of FIG. 8. For instance, the USB-4 protocol adapter circuitry 420 may be instantiated by the example microprocessor 900 of FIG. 9 executing machine executable instructions such as those implemented by at least blocks 710 of FIG. 7. In some examples, the USB-4 protocol adapter circuitry 420 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the USB-4 protocol adapter circuitry 420 may be instantiated by any other combination of hardware, software, and/or firmware. For example, the USB-4 protocol adapter circuitry 420 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the host system 400 includes means for entering a second connection mode. For example, the means for entering the second connection mode may be implemented by connection management circuitry 426. In some examples, the connection management circuitry 426 may be instantiated by programmable circuitry such as the example programmable circuitry 812 of FIG. 8. For instance, the connection management circuitry 426 may be instantiated by the example microprocessor 900 of FIG. 9 executing machine executable instructions such as those implemented by at least blocks 702-708 of FIG. 7. In some examples, the connection management circuitry 426 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the connection management circuitry 426 may be instantiated by any other combination of hardware, software, and/or firmware. For example, the connection management circuitry 426 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

FIG. 5A illustrates an example USB-4 packet structure which may be used to implement CXL over USB-C using the second connection mode of FIG. 1B. FIG. 5B illustrates an example protocol definition field which may be used to implement CXL over USB-C using the second connection mode of FIG. 1B. FIGS. 5A and 5B include an example header region 502, an example payload region 504, and an example table 506.

The USB-4 protocol adapter circuitry 420 of this example converts CXL packets from the PCIe/CXL control circuitry 214 to USB-4 transport layer packets as described above in connection with FIG. 4. USB-4 transport layer packets have a 4-byte header region 502 and a 256-byte payload region 504. The header region 502 of this example includes a protocol definition field (PDF) that contains a unique identification based on the type of CXL packet tunneled, out-of-band and ordered sets. In some examples, the CXL.io and CXL.mem/CXL.cache paths are interleaved. The table 506 of the example FIG. 5B lists the PDF used by the USB-4 protocol adapter circuitry 420 for tunneling CXL packets in this example. The connection manager software/firmware within the USB4 control circuitry 418 can use the table 506 to determine if the CXL packets are 68 bytes or 256-bytes flits at end of training.

FIG. 5A shows a USB-4 tunnel packet structure. Unlike other PCIe flits, CXL flits have a fixed size of either 68 bytes or 256-bytes. CXL packets of 256-bytes include data integrity with cyclic redundancy check (CRC) and forward error correction code (FEC) for 256-byte flits.

Advantageously, the USB-4 protocol adapter circuitry 420 does not change the size (e.g., strip, truncate, add, etc.) of USB-4 headers when implementing the second connection mode disclosed herein. Accordingly, the USB-4 protocol adapter circuitry 420 tunnels CXL into USB packets (e.g., USB-4 packets) with improved latency, reduced processing, and reduced power consumption compared to tunneling other PCIe, USB3.2, DP protocols into USB-4. Furthermore, the fixed flit size of CXL simplifies packing CXL data inside the USB-4 packet structure.

The USB-4 protocol adapter circuitry 420 of this example uses PDF bit indices 3 and 4 of the table 506 to identify whether the flit header uses 68 byte or 256-byte flits. The USB-4 protocol adapter circuitry 420 then fills the payload region 504 and the PDF within the header region 502 based on the identification.

The USB-4 protocol adapter circuitry 420 of this example packages a plurality of CXL data flits into the payload of the message. In particular, the USB-4 protocol adapter circuitry 420 may package three 68-byte CXL flits into the 256-byte wide USB-4 payload region 504. The USB-4 protocol adapter circuitry 420 then: (a) zero pads the rest of the payload region 504, or (b) uses the rest of the payload region 504 for other packet and link management features. Alternatively, the USB-4 protocol adapter circuitry 420 may package one 256-byte CXL flit directly into the USB-4 payload region 504 (which is 256 bytes wide).

In some examples, the USB-4 protocol adapter circuitry 420 does not package synchronization headers that are optionally present in 68-byte CXL flits. In such examples, the synchronization headers may be generated later by the PHY circuitry 222.

While an example manner of implementing the host system 200 and the host system 400 are illustrated in FIGS. 2-4, one or more of the elements, processes, and/or devices illustrated in FIGS. 2-4 may be combined, divided, re-arranged, omitted, eliminated, and/or implemented in any other way. Further, the host memory 204, an example USB-C port 206, the SoC 208, the memory control circuitry 210, the SoC control circuitry 212, the PCIe/CXL control circuitry 214, the IO control circuits 216, the HSIO multiplexer 218, the multiplexer management circuitry 220, the PHY circuitry 222, the VR circuitry 302, the PD circuitry 304, the SBU multiplexer 306, the IO control circuits 416, the USB4 control circuitry 418, and/or, more generally, the host system 200 and host system 400 of FIGS. 2-4, may be implemented by hardware alone or by hardware in combination with software and/or firmware. Thus, for example, any of the host memory 204, an example USB-C port 206, the SoC 208, the memory control circuitry 210, the SoC control circuitry 212, the PCIe/CXL control circuitry 214, the IO control circuits 216, the HSIO multiplexer 218, the multiplexer management circuitry 220, the PHY circuitry 222, the VR circuitry 302, the PD circuitry 304, the SBU multiplexer 306, the IO control circuits 416, the USB4 control circuitry 418, and/or, more generally, the host system 200 and the host system 400 of FIGS. 2-4, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example the host system 200 and the host system 400 may include one or more elements, processes, and/or devices in addition to, or instead of, those illustrated in FIGS. 2-4, and/or may include more than one of any or all of the illustrated elements, processes and devices.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share the same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Flowchart(s) representative of example machine-readable instructions, which may be executed by programmable circuitry to implement and/or instantiate the host system 200 and host system 400 of FIGS. 2-4 are shown in FIGS. 6 and 7. The machine-readable instructions may be one or more executable programs or portion(s) of one or more executable programs for execution by programmable circuitry such as the programmable circuitry 812 shown in the example programmable circuitry platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6 and 7, many other methods of implementing the example host systems 200 and 400 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions disclosed herein may be stored in one or more of a compressed format, an encrypted format, a fragmented format, a compiled format, an executable format, a packaged format, etc. Machine readable instructions as disclosed herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that disclosed herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions disclosed herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6 and 7 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second”, etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine-readable instructions and/or example operations 600 that may be executed, instantiated, and/or performed by example programmable circuitry to implement the host system 200 to perform an example discovery and entry into the first connection mode of CXL over USB-C of FIG. 1A. In the example of FIG. 6, the host system 200 operates as a PCIe/CXL power delivery source and the USB-C enabled device 202 operates as a PCIe/CXL power delivery sink.

The example machine-readable instructions and/or the example operations 600 of FIG. 6 begin when the PD circuitry 304 transmits a request for a Standard Vendor Identification (SVID) value to the USB-C enabled device 202. (Block 602). The PD circuitry 304 transmits the request to the USB-C enabled device 202 using the CC pins 312 coupled the USB-C port 206. The SVID is a 16-byte value defined by PCI-SIG and present within all devices that use a PCIe protocol. The SVID identifies a specific vendor and/or model of a given PCIe device.

The PD circuitry 304 receives an SVID value from the USB-C enabled device 202. (Block 604). The PD circuitry 304 receives the SVID over the CC pins 312 and transmits the SVID to the multiplexer management circuitry 220 using either a GPIO pin or a I2C connection between the PD circuitry 304 and the SoC 208.

The multiplexer management circuitry 220 causes the PD circuitry 304 to transmit a request to discover modes to the USB-C enabled device 202. (Block 606). The request to discover modes is a request for the USB-C enabled device 202 to identify which communication modes (e.g., the CXL alternate/first connection mode disclosed herein, the CXL tunneling/second connection mode disclosed herein, USB 4, USB 3.2, DisplayPort 2.1, etc.) it supports.

The PD circuitry 304 receives a mode-support message over the CC pins 312. (Block 608). The mode-support message is a VDM transmitted by the USB-C enabled device 202. The mode-support message includes a response to the request of block 606. For example, as described above in Table 1, bits 31:24 of a VDM provided in block 608 may be set to 0x02 to indicate the USB-C enabled device 202 supports the first connection mode. The mode-support message of block 608 also indicates whether a single or dual lane link connection should be used to communicate with the USB-C enabled device 202.

The PD circuitry 304 determines whether the USB-C enabled device 202 supports the CXL first connection mode. (Block 610). The PD circuitry 304 makes the determination by interpreting the VDM of block 608 using Table 1 described above. If the USB-C enabled device 202 does not support CXL first connection mode (block 610: No), and the machine-readable instructions and/or operations 600 end. The SoC 208 may additionally or alternatively discover other alternate communication modes if the USB-C enabled device 202 does not support CXL first connection mode (block 610: No).

If the USB-C enabled device 202 does support CXL first connection mode (block 610: Yes), the PD circuitry 304 uses the CC pins 312 to transmit a message to the USB-C enabled device 202. (Block 612). The message of block 612 instructs the USB-C enabled device 202 to enter the CXL first connection mode. At block 612, the PD circuitry 304 also informs the multiplexer management circuitry 220 of the first connection mode using either a GPIO pin or the I2C connection between the PD circuitry 304 and the SoC 208.

The PD circuitry 304 receives an acknowledgement message over the CC pins 312. (Block 614). The message of block 614 shows that the USB-C enabled device 202 has acknowledged the instructions of block 612 and entered the first connection mode.

The multiplexer management circuitry 220 causes the PD circuitry 304 to transmit a CXL status message to the USB-C enabled device 202. (Block 616). The update status message is a second VDM defined in Table 2 above. Accordingly, the status message of block 616 updates the USB-C enabled device 202 with a change in PCIe status information (e.g., a change in one or more of the PERST signal 312A, the CLKREQ signal 312B, the wake signal 312C, and the hot plug signals 312D). The multiplexer management circuitry 220 causes the PD circuitry 304 to transmit a CXL status message based on a determination that the signals on the SBU pins 314 have changed states (e.g., changed between the AUX channel 314A if in DP.21 mode, the LSx signal 314B if in USB4-TBT mode, or the PCIe Ref CLK signal 314C if in CXL/PCIe mode as described above).

The PD circuitry 304 receives an acknowledgement message over the CC pins 312. (Block 618). The message of block 618 shows that the USB-C enabled device 202 has acknowledged the status update of block 616. The first connection mode is entered after block 618, and both the host system 200 and USB-C enabled device are able to exchange CXL messages over the USB-C port as an alternate protocol. Accordingly, the machine-readable instructions and/or operations 600 end.

FIG. 7 is a flowchart representative of example machine-readable instructions and/or example operations 700 that may be executed, instantiated, and/or performed by example programmable circuitry to implement the host system 400 and enter CXL tunnel on USB4 over USB-C using the second connection mode disclosed herein. The example of FIG. 7 includes the host system 400 of FIG. 4 and the USB-C enabled device 202.

The example machine-readable instructions and/or example operations 700 begin when the connection management circuitry 426 of the host system 400 initializes a USB 4 connection. (Block 702). To initialize the USB 4 connection, the connection management circuitry 426 may discover configuration parameters, topology ID, and hot plug status within the USB4 control circuitry 418.

The connection management circuitry 426 of the host system 400 reads and updates the router configuration register 428 for CXL parameters from the USB-C enabled device 202. (Block 704). In particular, the connection management circuitry 426 reads ROUTER_CS_5[22] and ROUTER_CS_6[5] from the router configuration register 428 (as described above in connection with FIG. 4) to update the CXL tunnel status to ON and update the CXL wake status to ON.

The connection management circuitry 426 of the host system 400 reads and updates the adapter configuration register 430 to provide additional CXL parameters. (Block 706). In particular, the connection management circuitry 426 reads the Adapter Configuration Space Register 2 (ADP_CS_2), a register defined in the USB4 specification, to detect: (a) the CXL protocol type or subtype, and (b) the protocol version, for the USB-C enabled device 202.

The connection management circuitry 426 of the host system 400 reads and updates a path configuration. (Block 708). The path configuration of block 708 refers to an address space that connects the CXL adapter on the host system 400 with the CXL adapter on the USB-C enabled device 202. The host system 400 and the USB-C enabled device 202 discover the CXL adapters of the respective devices through the router configuration space discovery technique described above in connection with the connection management circuitry 426. In some examples, the path configuration of block 708 is referred to as a CXL tunnel path. Accordingly, the host system 400 may use the tunnel path to tunnel CXL packets tunnel through the CXL adapters to the USB-C enabled device 202.

After initializing the CXL tunnel path, the USB-4 protocol adapter circuitry 420 and the USB-C enabled device 202 exchange USB4 packets (e.g., USB-4 packets) that tunnel CXL data. (Block 710). The packets of block 710 implement the format defined above in connection with FIGS. 5A and 5B. The example machine-readable instructions and/or operations 700 end after block 710.

FIG. 8 is a block diagram of an example programmable circuitry platform 800 structured to execute and/or instantiate the example machine-readable instructions and/or the example operations of FIGS. 6 and 7 to implement the host systems 200 and 400 of FIGS. 2, 3, and 4. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements, the memory control circuitry 210, the SoC control circuitry 212, the PCIe/CXL control circuitry 214, the IO control circuits 216, the HSIO multiplexer 218, the multiplexer management circuitry 220, the PHY circuitry 222, the VR circuitry 302, the PD circuitry 304, the SBU multiplexer 306, the IO control circuits 416, the USB4 control circuitry 418, and/or, more generally, the SoC 208 of FIGS. 2-3 and the SoC 408 of FIG. 4.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816. In this example, the memory controller 817 implements the memory control circuitry 210.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this example, the interface circuitry 820 implements the USB-C ports 206.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 832, which may be implemented by the machine-readable instructions of FIGS. 6 and 7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 6 and 7 to effectively instantiate the circuitry of FIG. 2 as logic circuits to perform operations corresponding to those machine-readable instructions. In some such examples, the circuitry of FIGS. 2, 3, and 4 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine-readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine-readable instructions and/or operations represented by the flowcharts of FIGS. 6 and 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine-readable instructions. However, once configured, the FPGA circuitry 1000 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine-readable instructions represented by the flowchart(s) of FIGS. 6 and 7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 6 and 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6 and 7. As such, the FPGA circuitry 1000 may be configured and/or structured to effectively instantiate some or all of the operations/functions corresponding to the machine-readable instructions of the flowchart(s) of FIGS. 6 and 7 as dedicated logic circuits to perform the operations/functions corresponding to those software instructions in a dedicated manner analogous to an ASIC. Therefore, the FPGA circuitry 1000 may perform the operations/functions corresponding to the some or all of the machine-readable instructions of FIGS. 6 and 7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine-readable instructions of FIGS. 6 and 7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe/CXL controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine-readable instructions represented by the flowchart(s) of FIGS. 6 and 7 to perform first operation(s)/function(s), the FPGA circuitry 1000 of FIG. 10 may be configured and/or structured to perform second operation(s)/function(s) corresponding to a second portion of the machine-readable instructions represented by the flowcharts of FIGS. 6 and 7, and/or an ASIC may be configured and/or structured to perform third operation(s)/function(s) corresponding to a third portion of the machine-readable instructions represented by the flowcharts of FIGS. 6 and 7.

It should be understood that some or all of the circuitry of FIGS. 2, 3, and 4 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIGS. 2, 3, and 4 may be instantiated, for example, in one or more threads executing concurrently and/or in series. For example, the microprocessor 900 of FIG. 9 may execute machine-readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIGS. 2, 3, and 4 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

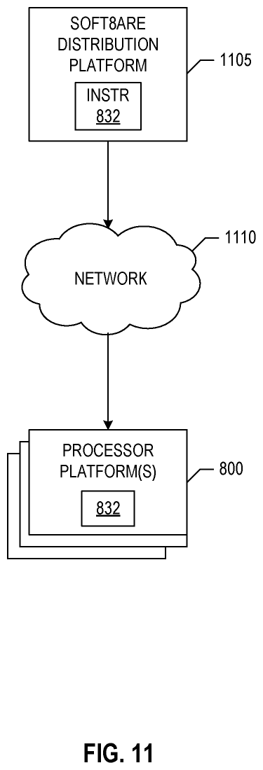

A block diagram illustrating an example software distribution platform 1105 to distribute software such as the example machine-readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine-readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine-readable instructions 832, which may correspond to the example machine-readable instructions of FIGS. 6 and 7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 832 from the software distribution platform 1105. For example, the software, which may correspond to the example machine-readable instructions of FIGS. 6 and 7, may be downloaded to the example programmable circuitry platform 800, which is to execute the machine-readable instructions 832 to implement the host systems 200 and 400. In some examples, one or more servers of the software distribution platform 1105 periodically offer, transmit, and/or force updates to the software (e.g., the example machine-readable instructions 832 of FIG. 8) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed herein that use USB-C to communicate using the CXL protocol. Disclosed systems, apparatus, articles of manufacture, and methods improve the efficiency of using a computing device by implementing either a first connection mode or a second connection mode as disclosed herein. In a first connection mode, CXL is used as an alternate protocol (instead of a USB-IF defined protocol). In a second connection mode, a CXL IP core connects to a USB-4 IP core and CXL packets are tunneled into USB packets (e.g., USB-4 packets). Using either mode enables devices to communicate using CXL over USB-C (e.g., over a USB-C port), thereby supporting additional applications that are not supported by other USB-C devices. For example, CXL over USB-C enables heterogeneous computing using disaggregated resources. The resources can be storage memory or accelerators spread across many servers while provisioning coherent global access among all servers connected over the network. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to implement CXL over USB-C are disclosed herein. Further examples and combinations thereof include the following.

Example 1 includes an apparatus comprising a USB-C port, power delivery circuitry to determine, based on a mode-support message access via the USB-C port, that an external device supports Compute Express Link (CXL) as a standalone protocol over USB-C, and multiplexer management circuitry to cause the power delivery circuitry to transmit a CXL status message to the external device via the USB-C port.

Example 2 includes the apparatus of example 1, further including physical layer circuitry to connect CXL control circuitry to the USB-C port, the physical layer circuitry to include an electrical device that supports a voltage present in CXL messages.

Example 3 includes the apparatus of example 1, wherein the CXL status message includes a set of Peripheral Component Interconnect express (PCIe) signals, and including CXL control circuitry to form CXL messages based on the set of PCIe signals.

Example 4 includes the apparatus of example 3, wherein the PCIe signals include at least one of a PCIe Reset (PERST) signal, a reference clock signal, a wake signal, a clock request signal, or a hot plug signal.

Example 5 includes the apparatus of example 3, further including SoC control circuitry, root complex circuitry, CXL.IO protocol circuitry, CXL.memory protocol circuitry, and CXL.cache protocol circuitry.

Example 6 includes the apparatus of example 3, wherein the power delivery circuitry is to obtain the set of PCIE signals using Communication Channel (CC) pins.

Example 7 includes the apparatus of example 1, wherein the multiplexer management circuitry is to obtain the mode-support message from the power delivery circuitry over a general purpose input output (GPIO) pin.

Example 8 includes the apparatus of example 1, wherein the multiplexer management circuitry is to obtain the mode-support message from the power delivery circuitry over an inter-integrated circuit (I2C) pin.

Example 9 includes the apparatus of example 1, wherein the mode-support message is a Vendor Defined Message (VDM).

Example 10 includes an apparatus comprising physical layer circuitry, and USB control circuitry to determine a message obtained via a USB-C port includes Compute Express Link (CXL) data, and cause tunnelling of the CXL data into one or more USB packets.

Example 11 includes the apparatus of example 10, wherein the USB control circuitry is to determine the message includes the CXL data based on a protocol definition field (PDF) within a header of the message.

Example 12 includes the apparatus of example 10, wherein the USB control circuitry is to update a CXL tunnel status and/or a CXL wake status of a router configuration register.

Example 13 includes the apparatus of example 10, wherein the USB control circuitry is to update at least one of a CXL protocol type, protocol version, or a tunnel path of an adapter configuration register.

Example 14 includes the apparatus of example 10, wherein the USB control circuitry is to cause tunnelling of a plurality of CXL data flits into a payload of the message.

Example 15 includes a non-transitory machine-readable storage medium comprising instructions to cause a machine to at least determine, based on a mode-support message obtained via a USB-C port, that an external device supports Compute Express Link (CXL) as a standalone protocol over USB-C, and transmit, after the determination, a CXL status message to the external device via the USB-C port.

Example 16 includes the non-transitory machine-readable storage medium of example 15, wherein the CXL status message includes a set of Peripheral Component Interconnect express (PCIe) signals, and the instructions cause the machine to provide a set of Peripheral Component Interconnect express (PCIe) to CXL control circuitry, the CXL control circuitry to communicate with physical layer circuitry based on the set of PCIe signals.

Example 17 includes the non-transitory machine-readable storage medium of example 16, wherein the PCIe signals include at least one of a PCIe Reset (PERST) signal, a reference clock signal, a wake signal, a clock request signal, or a hot plug signal.

Example 18 includes the non-transitory machine-readable storage medium of example 16, wherein the instructions cause the machine to obtain the set of PCIE signals using Communication Channel (CC) pins.

Example 19 includes the non-transitory machine-readable storage medium of example 15, wherein the mode-support message is a Vendor Defined Message (VDM).

Example 20 includes a non-transitory machine-readable storage medium comprising instructions to cause a machine to at least determine a message obtained via a USB-C port includes Compute Express Link (CXL) data, and cause tunnelling of the CXL data into USB packets.

Example 21 includes the non-transitory machine-readable storage medium of example 20, wherein the instructions cause the machine to determine the message includes the CXL data based on a protocol definition field (PDF) within a header of the message.

Example 22 includes the non-transitory machine-readable storage medium of example 20, wherein the instructions cause the machine to update a CXL tunnel status and/or a CXL wake status of a router configuration register.

Example 23 includes the non-transitory machine-readable storage medium of example 20, wherein the instructions cause the machine to update at least one of a CXL protocol type, protocol version, and/or a tunnel path of an adapter configuration register.

Example 24 includes the non-transitory machine-readable storage medium of example 20, wherein the instructions cause the machine to tunnel a plurality of CXL data flits into a payload of the message.

Example 25 includes the non-transitory machine-readable storage medium of example 20, wherein the USB packets are USB-4 packets.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
a USB-C port;
power delivery circuitry to determine, based on a mode-support message access via the USB-C port, that an external device supports Compute Express Link (CXL) as a standalone protocol over USB-C; and
multiplexer management circuitry to cause the power delivery circuitry to transmit a CXL status message to the external device via the USB-C port.

2. The apparatus of claim 1, further including physical layer circuitry to connect CXL control circuitry to the USB-C port, the physical layer circuitry to include an electrical device that supports a voltage present in CXL messages.

3. The apparatus of claim 1, wherein the CXL status message includes a set of Peripheral Component Interconnect express (PCIe) signals; and including:
CXL control circuitry to form CXL messages based on the set of PCIe signals.

4. The apparatus of claim 3, wherein the PCIe signals include at least one of:
a PCIe Reset (PERST) signal;
a reference clock signal;
a wake signal;
a clock request signal; or
a hot plug signal.

5. The apparatus of claim 3, further including:
SoC control circuitry;
root complex circuitry;
CXL.IO protocol circuitry;
CXL.memory protocol circuitry; and
CXL.cache protocol circuitry.

6. The apparatus of claim 3, wherein the power delivery circuitry is to obtain the set of PCIE signals using Communication Channel (CC) pins.

7. The apparatus of claim 1, wherein the multiplexer management circuitry is to obtain the mode-support message from the power delivery circuitry over a general purpose input output (GPIO) pin.

8. The apparatus of claim 1, wherein the multiplexer management circuitry is to obtain the mode-support message from the power delivery circuitry over an inter-integrated circuit (I2C) pin.

9. The apparatus of claim 1, wherein the mode-support message is a Vendor Defined Message (VDM).

10. An apparatus comprising:
physical layer circuitry; and
USB control circuitry to:
determine a message obtained via a USB-C port includes Compute Express Link (CXL) data; and
cause tunnelling of the CXL data into one or more USB packets.

11. The apparatus of claim 10, wherein the USB control circuitry is to determine the message includes the CXL data based on a protocol definition field (PDF) within a header of the message.

12. The apparatus of claim 10, wherein the USB control circuitry is to update a CXL tunnel status and/or a CXL wake status of a router configuration register.

13. The apparatus of claim 10, wherein the USB control circuitry is to update at least one of a CXL protocol type, protocol version, or a tunnel path of an adapter configuration register.

14. The apparatus of claim 10, wherein the USB control circuitry is to cause tunnelling of a plurality of CXL data flits into a payload of the message.

15-19. (canceled)

20. A non-transitory machine-readable storage medium comprising instructions to cause a machine to at least:
determine a message obtained via a USB-C port includes Compute Express Link (CXL) data; and
cause tunnelling of the CXL data into USB packets.

21. The non-transitory machine-readable storage medium of claim 20, wherein the instructions cause the machine to determine the message includes the CXL data based on a protocol definition field (PDF) within a header of the message.

22. The non-transitory machine-readable storage medium of claim 20, wherein the instructions cause the machine to update a CXL tunnel status and/or a CXL wake status of a router configuration register.

23. The non-transitory machine-readable storage medium of claim 20, wherein the instructions cause the machine to update at least one of a CXL protocol type, protocol version, and/or a tunnel path of an adapter configuration register.

24. The non-transitory machine-readable storage medium of claim 20, wherein the instructions cause the machine to tunnel a plurality of CXL data flits into a payload of the message.

25. The non-transitory machine-readable storage medium of claim 20, wherein the USB packets are USB-4 packets.
